(19) United States
(12) Patent Application Publication
(10) Pub. No.: US 2005/0221264 A1
(43) Pub. Date: Oct. 6, 2005

(54) Method and system for on-line and in-person skills training

(76) Inventors: Peter Hearn, Brookfield, CT (US); Scott Wyshynski, Brookfield, CT (US)

Correspondence Address: DARBY & DARBY P.C., P. O. BOX 5257, NEW YORK, NY, 10150-5257, US

(21) Appl. No.: 11/093,982

(22) Filed: Mar. 30, 2005

Related U.S. Application Data
(60) Provisional application No. 60/558,164, filed on Mar. 30, 2004.

(51) Int. Cl. G09B 7/00

(52) U.S. Cl. 434/322

(57) ABSTRACT

A method for training a student in a skill over a network and a student accesses the system and it displays a list of at least one training location. In one embodiment, the preferred training location sells training materials to the student and the student identifies that he is ready to be tested. The invention transmits, to the student, at least one of a first set of questions based on the skill. Once the answer is received, it is responded to in real time. An embodiment determines if the answer is one of a correct answer or a wrong answer and either a correct or an incorrect notification is sent to the student. Both the correct and incorrect notifications can be edited and can be customized for each training location to include an advertisement for the product in a response regarding products related to the question.

### BACKGROUND OF THE INVENTION

I. Field of the Invention

The present invention relates to a method and system for skills training both on-line and in-person. More particularly, on-line training of the information required for performing a skill and in person training of the actual skill.

II. Discussion of the Related Art

Traditional skills training involves both classroom time and physical practice time. A student must attend a class to receive instruction regarding the information surrounding the skill to be learned. The classes are typically at a fixed time and location and are sometimes inconvenient for the student to attend. The classes are typically not offered more than once or twice in a given session and if a student misses a class, the student must either learn the material on his own or delay his certification until the class can be taken. Certification exams are typically given at the end of the classroom session to verify that the student has learned the necessary information to pass to the physical training portion.

An example of the traditional skill training session is for lifeguard training. Sessions given by the American Red Cross involve both classroom and physical training. Classroom education for a lifeguard revolves around the basics of rescuing drowning individuals. Also instruction of the identification and uses for the basic lifesaving equipment, including hooks, life preservers, floats, respirators, and backboards. The classroom training is divided into chapters and quizzes can be offered after each chapter. At the end of the classroom training a certification exam is given and a passing grade is required for certification. Additionally, physical training at a body of water, e.g. a pool, is also required and can be given after the classroom training is complete or classroom and physical training can be given alternately once the students have studied the information necessary for the physical training. The physical training involves practicing simulated rescues involving different victims and situations.

The training session can be long and time consuming. The classroom training can be long, boring, and, for some students, not offered at convenient times and locations. An object of the present invention is to provide on-line training for students involved in a skill training session while providing for the physical training aspect of training in-person.

Further, on-line classes and examinations are known in the art, however, it is typically not linked to a physical training event. Most on-line or remote teaching and testing systems completely replace any physical interaction between the student and the teacher and allow to the student to learn all of the information without guidance or supervision of a qualified instructor. The drawbacks to these systems are that the students do not get substantive feedback on the answers to their questions and information regarding the context of the material being taught. Information and feedback is typically offered by the live instructor.

Furthermore, the locations that offer the training want the students to attend classes and training at their establishment to “bond” with the student. Often the training location may also have a retail business associated with the trained skill. For example, the skill of scuba diving requires both classroom and physical training and is usually taught by representatives of a scuba equipment store. The representatives want the student to become a customer of the business and want to form a connection with the student.

The business representatives prefer the student in the classroom to show them the equipment and be able to “advertise” during class to promote the particular equipment in hopes of a sale. The advertising is typically done contemporaneously with the instruction regarding the equipment. For example, the business representative may bring different brands of scuba masks for the students to try on during the lesson on masks hoping students will purchase a mask. Traditional on-line training techniques prevent the business representatives and the student from forming a personal relationship and prevent the business from advertising their goods. Other on-line systems do allow images of preferred products to be displayed to a student but the display is not linked to test questions regarding the product.

There is a need in the art for on-line training that allows the student and teacher to interact and to allow a retailer of goods to advertise their goods during the classroom training portion and particularly linking the product to questions based on the product or use of the product.

### SUMMARY OF THE INVENTION

The present invention is a method for training a student in a skill, in particular over a network. The method can be used to teach a skill that may require both learned knowledge and physical training. The invention is described in an example of training a student how to scuba dive.

A student accesses the system and it displays a list of at least one training location. Training locations are, at least, the business location where the instructors have their retail location and can be a listing of training cites where the actual physical training is performed. Knowledge of not only the retail location but also the training cites let the student pick the most convenient training location and the invention receives, from the student, a preferred training location selected from the list of training locations.

In one embodiment, the preferred training location sells training materials to the student at the preferred training location and once the student has reviewed his training materials, he is ready to be quizzed on the material to test his knowledge. The training materials can be divided into chapters and sub-chapters and quizzes can be provided at any point or points within the training materials.

When the student identifies that he is ready to be tested, the invention transmits, to the student, at least one of a first set of questions based on the skill. The questions can be further based on the training materials received from the preferred training location. The questions can be modified to suit the training materials and the preference of the instructor. The first set of questions can be based on any one chapter or sub-chapter in the training materials or on all the information required for the skill. Any number of questions can be asked on the subject matter.

The answer to the question is received from the student and is typically received after the student clicks a “send” or “done” button on the system to initiate sending the answer. Once the answer is received, it is responded to in real time. An embodiment determines if the answer is one of a correct answer or a wrong answer. If the answer is a correct answer, a correct notification is sent to the student and can include the correct answer, a value of the question, a relationship between the question and the skill, a relationship between the question and a physical aspect of the skill, and a time during the training when the physical aspect of the skill is performed. Alternately, if the student answered with the wrong answer, an incorrect notification is sent to the student. The incorrect notification includes the wrong answer and the correct answer and can alternately include a value of the question, a relationship between the question and the skill, a relationship between the question and a physical aspect of the skill, and a time during the training when the physical aspect of the skill is performed.

In an embodiment, both the correct and incorrect notifications can be edited by an instructor and can be customized for each training location. This allows each location to include important information specific to diving in the region surrounding the training location. For example, native plants and fish that may be harmful to divers. This also allows the program to be modified to fit the individual training styles of the instructors who teach the course.

Another embodiment includes determining a product related to the questions and including an advertisement for the product in a response. A retail location can provide information regarding products in stock that are related to the question. For example, if the question is regarding the proper procedure to clear a dive mask, the response can include an advertisement for a dive mask that is “quick and easy to clear.” The advertisements can further include travel and vacation information geared to diving.

Once the student has completed all of the chapters and answered enough questions to receive a passing grade. The student can then be required to take his final certifying exam. The student is queried, at the training location, with at least one of a second set of questions based on the skill. The second set of questions can be on the certifying exam and again based on the training materials and can be modified for each instructor. Alternately, the certifying exam can be a standardized test given by a standards group and cannot be altered by the individual training locations. Once the student has completed some or all of the questions regarding the skill, the student is trained in a physical aspect of the skill at the preferred training location. The physical training can occur during the questioning process outlined above. The student completes a chapter and then schedules a physical training session based on the completed materials.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a flow chart of a skill training method of the present invention; and

FIG. 2 is a flow chart of an embodiment of the skill training method of FIG. 1.

### DETAILED DESCRIPTION OF THE PREFERRED EMBODIMENT

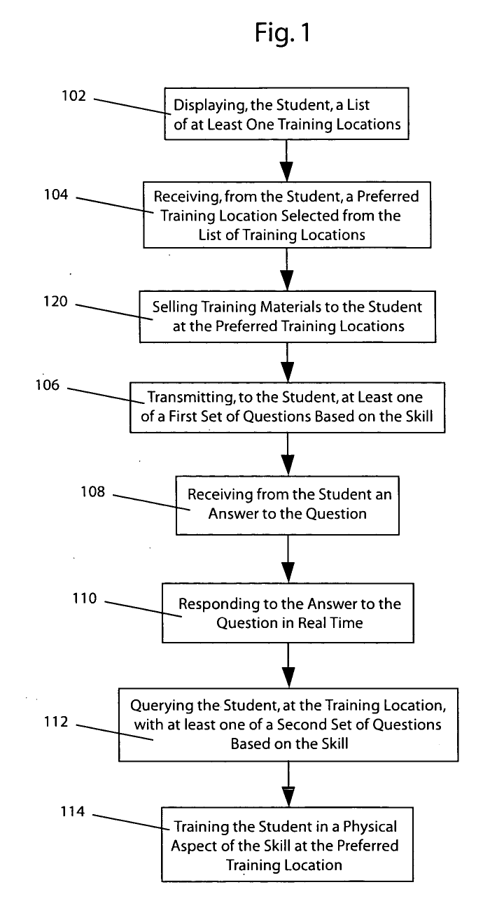

Referring now to FIG. 1, a method for training a student in a skill partially over a network is illustrated. The method can be used to teach a skill that may require both learned knowledge and physical training. The inventors contemplate this method can be used in most training situations, for example, lifeguard, water safety instructor, pilot, mechanic, tractor trailer driver, automobile driver, heavy equipment operator, police officer, fireperson, first aid, cardiopulmonary resuscitation (CPR), and paramedic. The training can be for both professional and recreational skills. The invention is described below in an example of training a student how to scuba dive.

A typical student interested in learning how to scuba dive can go onto a network to gather information regarding learning how to dive. Typically the student accesses the Internet or World Wide Web in search of information on a web site. The student can access the network from any network compatible device including a computer, PDA, and cell phone. Once the student accesses the system, it displays, to the student, a list of at least one training locations (step 102). Training locations are, at least, the business location where the instructors have their retail location. Additionally, and distinct from the prior art, are a listing of training cites where the actual physical training is performed. For example, scuba retail locations in urban areas typically do not have a pool attached where they perform practice dives. Typically the scuba trainers rent a pool from a local gym, spa, school, or a YMCA. Students pick training locations typically by proximity to where they live or work. Knowledge of not only the retail location but also the training cites let the student pick the most convenient training location and the invention receives, from the student, a preferred training location selected from the list of training locations (step 104). The preferred training location is the location where the student's instructor typically works and the training schedule the student will follow.

In one embodiment, the preferred training location sells training materials to the student at the preferred training location (step 120). The training materials can be text books, video tapes, audio tapes, flashcards, CD-Rom, DVD, computer software or any combination of the above. The training materials can be selected and or modified by the preferred retail location and are the material the student studies from. Further, the training location can transmit the training materials to the student or transmit updates or inserts. For example, material relevant to diving in the particular geographical area can be sent by the specific training location to supplement the standard material. In an alternate embodiment, the training materials, including text, audio and video can be presented on-line in lieu of the training materials sold at the training location.

Once the student has reviewed his training materials, he is ready to be quizzed on the material to test his knowledge. The training materials can be divided into chapters and sub-chapters and quizzes can be provided at any point or points within the training materials. The student can log into the present invention to begin the quizzing process. At some point in the method, the student registered and provided all the information necessary to identify the student and the preferred training location. Additionally, the user can pay for the training and quizzes on-line. Other information can include a self assessed skill level in the skill or the identification of previous certifications or classes within the skill.

When the student identifies that he is ready to be tested, the invention transmits, to the student, at least one of a first set of questions based on the skill (step 106). The questions can be further based on the training materials received from the preferred training location. The questions can be modified to suit the training materials and the preference of the instructor. The first set of questions can be based on any one chapter or sub-chapter in the training materials or on all the information required for the skill. Any number of questions can be asked on the subject matter. The questions can be true/false; multiple choice; fill-in the blank; or essay style questions. Once the student answers the question, it is received from the student (step 108). Typically, the answer is received after the student clicks a “send” or “done” button on the system to initiate sending the answer to the invention.

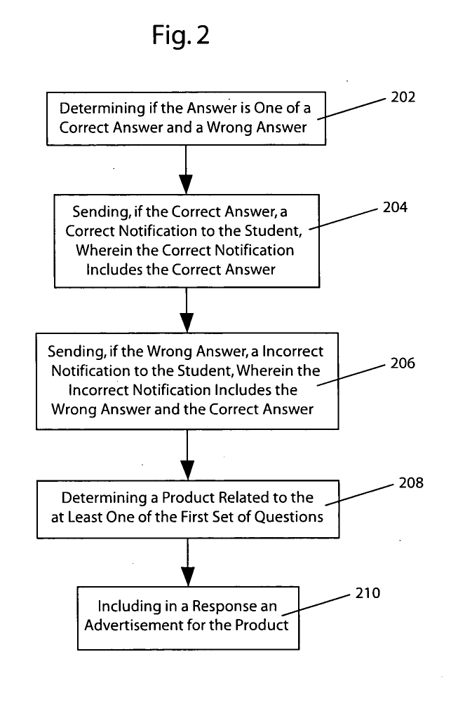

Once the answer is received, it is responded to in real time (step 110). In one embodiment, illustrated in FIG. 2, show the different responses. An embodiment determines if the answer is one of a correct answer and a wrong answer (step 202). The determination can be made by comparing the answer to an answer key in a database or software can review an essay answer and pull out the key words to compare them to a list of key words. If the answer is a correct answer, a correct notification is sent to the student (step 204). The correct notification can include the correct answer, a value of the question, a relationship between the question and the skill, a relationship between the question and a physical aspect of the skill, and a time during the training when the physical aspect of the skill is performed. Alternately, if the student answered with the wrong answer, an incorrect notification is sent to the student (step 206). The incorrect notification includes the wrong answer and the correct answer and can alternately include a value of the question, a relationship between the question and the skill, a relationship between the question and a physical aspect of the skill, and a time during the training when the physical aspect of the skill is performed.

In an embodiment, both the correct and incorrect notifications can be edited by an instructor and can be customized for each training location. This allows each location to include important information specific to diving in the region surrounding the training location. For example, native plants and fish that may be harmful to divers. This also allows the program to be modified to fit the individual training styles of the instructors who teach the course.

Further embodiments can transmit a copy of the completed questions, along with the answers and explanations to the student once the set of questions are completed and graded. The transmission can be in the form of a hard copy or an electronic copy, e.g. e-mail. Further, it can be a requirement that the student acknowledge the transmitted copy by, for example, signing and returning the transmitted copy to the training location.

Another embodiment of the responding step includes determining a product related to the questions (step 208) and including in a response an advertisement for the product (step 210). This is an important feature for retail training locations. A retail location can provide information regarding products in stock that are related to the question. For example, if the question is regarding the proper procedure to clear a dive mask, the response can include an advertisement for a dive mask that is “quick and easy to clear.” The advertisements can further include travel and vacation information geared to diving. For example, a dive trip to a reef or wreck either near by or at a known dive location anywhere in the world. What information can be included in the response can be selected by representative of the product or the preferred training location or some information from each party. The representative can customize the advertisements based on the geographic region. For example, the representative can advertise products for cold weather diving in the colder climates and can advertise different lines of products depending on the client base at the training location.

Another embodiment places a link in the response to provide audio, video or redirection to a web site for more information. Additionally, the instructor can be on-line and the student, while answering the questions, can instant message or e-mail the instructor for more information, hints or clarification. Also, the response can provide the instructor's e-mail address to provide an easy link to the instructor.

Once the student has completed all of the chapters and answered enough questions to receive a passing grade. The student can then be required to take his final certifying exam. The student is queried, at the training location, with at least one of a second set of questions based on the skill (step 112). The second set of questions can be on the certifying exam and again based on the training materials and can be modified for each instructor. Alternately, the certifying exam can be a standardized test given by a standards group and cannot be altered by the individual training locations. One of the benefits of an embodiment requiring a student to take a certifying exam at the training location is that the exam can be proctored and verified that the student truly performed the work and understands the material. The certifying exam can be given at the end of every chapter or can be one ‘final’ exam after all of the chapters have been completed.

Once the student has completed some or all of the questions regarding the skill, the student is trained in a physical aspect of the skill at the preferred training location (step 114). The physical training can occur during the questioning process outlined above. The student completes a chapter and then schedules a physical training session based on the completed materials. The present invention can provide for the scheduling of the physical training and notifying the preferred training location that the student has completed the requisite course work to be permitted to attend the physical training. Additionally, the student can be required to return the transmitted copy of the test questions prior to scheduling and/or the actual training to prove that the student took the quiz and received a passing grade.

All or some of the above embodiments can be used to comply with the training requirement set forth by accredited training agencies or with standard practices for certification by certifying agencies or organizations.

Further embodiments allow the student to select one or more preferred training locations. The student can take some or all of the physical and/or classroom training at multiple training locations. For example, the student can take the classroom portions at a local training location and take the physical aspect of the training at a different training location, e.g. a Caribbean resort where the student is vacationing. Further, the questions and advertisements can be tailored to one or both of the preferred locations. For example, the student can receive information regarding diving in both the local region and the Caribbean. Additional questions can be added to cover all geographical training locations and destinations. Furthermore, if the student responds to an advertisement for a location based trip, the training locations, questions and advertisements can be tailored to the location. For example, the student selects a Caribbean vacation, one or more training locations in the Caribbean can be displayed, for both classroom and physical training, as well as tailored questions and advertisements.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

1. A method for training a student in a skill partially over a network comprising the steps of:
transmitting, to the student, at least one of a first set of questions based on the skill;
receiving from the student an answer to at least one of the first set of questions;
responding to the answer to the first set of questions in real time;
determining a product related to the at least one of the first set of questions; and
including in the response an advertisement for the product.

2. The method of claim 1, further comprising the steps of:
displaying, to the student, a list of at least one training locations; and
receiving, from the student, a preferred training location selected from the list of training locations.

3. The method of claim 1, further comprising the step of querying the student, at a training location, with at least one of a second set of questions based on the skill.

4. The method of claim 1, further comprising the step of training the student in a physical aspect of the skill at a training location.

5. The method of claim 1, further comprising the step of selling training materials to the student at a training location.

6. The method of claim 5, wherein the first set of questions is based on the training materials.

7. The method of claim 3, wherein the second set of questions is based on training materials.

8. The method of claim 5, wherein the training materials are at least one of text books, video tapes, audio tapes, flashcards, CD-Rom, DVD, and computer software.

9. The method of claim 1, wherein the responding step comprises the steps of:
determining if the answer is one of a correct answer and a wrong answer;
sending, if the correct answer, a correct notification to the student, wherein the correct notification includes the correct answer; and
sending, if the wrong answer, a incorrect notification to the student, wherein the incorrect notification includes the wrong answer and the correct answer.

10. The method of claim 1, wherein the determining step is performed by a representative of the product.

11. The method of claim 1, the determining step is performed by the preferred training location.

12. The method of claim 1, wherein the responding step comprises the step of providing at least one of a value of the at least one first question, a relationship between the at least one first question and the skill, a relationship between the at least one first question and a physical aspect of the skill, and a time when the physical aspect of the skill is performed.

13. A method for training a student in a skill partially over a network comprising the steps of:
transmitting, to the student, at least one of a first set of questions based on the skill;
receiving from the student an answer to at least one of the first set of questions; and
responding to the answer to the first set of questions in real time, comprising the steps of:
determining if the answer is one of a correct answer and a wrong answer;
sending, if the correct answer, a correct notification to the student, wherein the correct notification includes the correct answer; and
sending, if the wrong answer, a incorrect notification to the student, wherein the incorrect notification includes the wrong answer and the correct answer.

14. The method of claim 13, further comprising the steps of:
displaying, to the student, a list of at least one training locations; and
receiving, from the student, a preferred training location selected from the list of training locations.

15. The method of claim 13, further comprising the step of querying the student, at a training location, with at least one of a second set of questions based on the skill.
